(19) United States
(12) Patent Application Publication
(10) Pub. No.: US 2009/0283552 A1
(43) Pub. Date: Nov. 19, 2009

(54) Straw Assembly for Compressed Air

(76) Inventor: Kang-Rim Choe, Daejeon (KR)

Correspondence Address: JORDAN AND HAMBURG LLP, 122 EAST 42ND STREET, SUITE 4000, NEW YORK, NY, 10168, US

(21) Appl. No.: 12/085,744

(22) PCT Filed: Oct. 18, 2006
(86) PCT No.: PCT/KR2006/004216

§ 371 Date: Aug. 19, 2008

(30) Foreign Application Priority Data
Dec. 7, 2005 (KR) 20-2005-0034484
Mar. 1, 2006 (KR) 10-2006-0019741
Sep. 26, 2006 (KR) 20-2006-0025803
Oct. 1, 2006 (KR) 20-2006-0027436

(51) Int. Cl. B65D 83/00; B67D 5/60

(52) U.S. Cl. 222/396; 222/464.1

(57) ABSTRACT

Disclosed is a straw assembly for compressed air, which is usable in an aerosol or spray injection pressure container. The compressed air has a high pressure of more than 5 kg/cm² and is filled in the container along with solution. The straw assembly includes a solution straw, a pressure regulator to reduce the pressure of the solution to an appropriate value so as to allow the compressed air to be used as an injection propellant for discharging the solution to the outside, and a safety valve or vinyl bag to prevent the compressed air from being discharged to the outside when the container is inverted. The straw assembly provides an eco-friendly product substituting the compressed air for liquefied gas that is used as an injection propellant for a conventional packing pressure container and achieves an aerosol or spray injection straw product having a low price.

### TECHNICAL FIELD

The present invention relates to a straw assembly for compressed air, which is usable in a packing pressure container of an aerosol or spray injection type, so as to substitute compressed air for liquefied gas that is conventionally used as an injection propellant.

### BACKGROUND ART

In general, a conventional packing pressure container, such as an aerosol or spray injection container, is configured in such a manner that a part of an interior space of the pressure container is filled with packing solution and liquefied gas as an injection propellant and the remaining part of the interior space is utilized for inducing expansion of the liquefied gas. The packing pressure container, which is filled with the solution and liquefied gas, has a constant internal pressure by a vapor pressure of the liquefied gas.

In operation, if an outlet valve installed to the pressure container is opened to discharge the solution received in the container to the outside in an aerosol or spray injection manner, both the solution and liquefied gas are sprayed simultaneously in a mixed state. The conventional pressure container is also provided therein with a straw, but the conventional straw simply serves to guide the solution to the outlet valve. Now, many problems of the above described conventional pressure container caused by using the liquefied gas as an injection propellant will be described as follows.

Firstly, when liquefied gas is sprayed into a living space, it may do harm to people or cause disagreeable environment.

Secondly, once being discharged to the atmosphere, liquefied gas has a possibility of creating a carcinogenic substance.

Thirdly, the use of liquefied gas always follows the risk of explosion and fire upon disposal as well as in normal use conditions.

Fourthly, if a vapor pressure of liquefied gas decreases, it causes solution to be sprayed in the form of lumps having a relatively large particle size.

Fifthly, a vapor pressure of liquefied gas is sensitive in a temperature variation, and in particular, exhibits a sudden reduction at a low temperature, making it difficult to achieve efficient spray of solution.

Sixthly, using liquefied gas as a filler is in itself a very dangerous work. In Korea, it is essential for containers using liquefied gas as a filler to acquire an inspection acknowledgement of Korea Gas Safety Corporation.

Seventhly, since it is essential to guarantee the use safety of liquefied gas, fabricating a container only using iron or aluminum-based materials cannot be permitted.

In addition to the above described problems, other various problems will be understood by those skilled in the art.

### DISCLOSURE OF INVENTION

### Technical Problem

Although it has been attempted to use compressed air as an injection propellant in a conventional aerosol or spray injection container, it was found that a pneumatic pressure produced in the container is sufficiently high at an initial stage of injection to achieve a sufficient injection distance of fine solution particles from the container, but is reduced gradually after the lapse of use time and results in deterioration in the injection distance and particle size, etc. at a last stage of injection. Also, if an outlet valve of the container is operated in a state wherein the container is inverted, it may cause a sudden discharge of the compressed air and consequently, reduction in the pneumatic pressure and a failure in injection operation. For this reason, no products using compressed air are commercialized up to now.

Therefore, the present invention has been made in view of the above problems, and it is an object of the present invention to provide a straw assembly for compressed air in which a straw is assembled with a pressure regulator and safety valve or vinyl bag, to enable compressed air to be used as an injection propellant of an aerosol or spray injection container instead of liquefied gas.

### Technical Solution

In accordance with one aspect of the present invention, the above and other objects can be accomplished by the provision of a straw assembly for compressed air, which is usable in an aerosol or spray injection type packing pressure container containing solution and compressed air substituting for liquefied gas, comprising: a valve unit to discharge the solution out of the container; a safety valve located below the valve unit and adapted to prevent discharge of the compressed air serving as an injection propellant when the container is inverted; a pressure regulator located below the valve unit and adapted to sequentially regulate a pressure of the solution to an injection pressure; and a solution straw coupled to a lower end of the pressure regulator to be installed on an extension axis of the pressure regulator.

In accordance with another aspect of the present invention, the above and other objects can be accomplished by the provision of a straw assembly for compressed air, which is usable in an aerosol or spray injection type packing pressure container containing solution and compressed air substituting for liquefied gas, comprising: a valve unit to discharge the solution out of the container; a pressure regulator located below the valve unit and adapted to sequentially regulate a pressure of the solution to an injection pressure; a solution straw coupled to a lower end of the pressure regulator to be installed on an extension axis of the pressure regulator; and a vinyl bag device attached to the solution straw and adapted to allow the solution to be injected without the leakage of the compressed air, the vinyl bag device comprising a vinyl bag, a fixture, and a stopper.

In accordance with yet another aspect of the present invention, the above and other objects can be accomplished by the provision of a straw assembly for liquefied gas, which is usable in an aerosol or spray injection type packing pressure container containing solution and liquefied gas, comprising: a valve unit to discharge the solution out of the container; a solution straw coupled to a lower end of the valve unit; and a vinyl bag device attached to the solution straw and adapted to allow the solution to be injected without the leakage of the liquefied gas, the vinyl bag device comprising a vinyl bag, a fixture, and a stopper.

### ADVANTAGEOUS EFFECTS

The present invention has the following several effects. Firstly, in view of the quality of products, the present invention can achieve efficient spray of fine particles over a relatively wide area, an increase in the space utility of a container based on the compression degree of compressed air, a rapid spray operation regardless of the surrounding temperature without risk of spray failure in all seasons, and provision of a synthetic resin container having a variety of shapes to fulfill the consumer's different tastes while providing an improvement in contact feeling. Secondly, in view of environmental protection and safety, the present invention enables the use of compressed air similar to the atmospheric air having no components harmful to human bodies as well as no risk of explosion, and this is effective to eliminate possibility of accidents. Thirdly, in view of economics, substituting the compressed air for liquefied gas can achieve a reduction in product costs while eliminating a need for additional costs required for the management of dangerous materials. In particular, when using a vinyl bag device instead of the safety valve, there is no risk of leakage or unintentional discharge of compressed air in use. As a result, the straw assembly is reusable so long as solution is recharged in the vinyl bag device. The use of the separate vinyl bag device, furthermore, has the effect of separating solution with compressed air or gas and therefore, the present invention is applicable to a variety of aerosol or spray containers receiving perfume, food, etc.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a straw assembly for compressed air according to a preferred first embodiment of the present invention;

FIG. 2 is a sectional view illustrating a straw assembly for compressed air according to a preferred second embodiment of the present invention;

FIG. 3 is a sectional view illustrating a straw assembly for compressed air according to a preferred third embodiment of the present invention;

FIG. 4 is a sectional view illustrating an alternative use example of the straw assembly according to the preferred third embodiment of the present invention;

FIGS. 5 to 8 are exemplary views of different pressure regulators for use in the straw assemblies of FIGS. 1, 2 and 3, and specifically,

FIG. 5 illustrating an air chamber type pressure regulator;

FIG. 6 illustrating another air chamber type pressure regulator;

FIG. 7 illustrating a pressure regulator of a type having a hole to be opened and closed based on a flow rate of solution or compressed air;

FIG. 8 illustrating a filter type pressure regulator;

FIG. 9 is a detailed configuration view of a safety valve shown in FIGS. 1 and 2;

FIG. 10 is a view illustrating a normal operating state of the straw assembly of FIG. 1;

FIG. 11 is a view illustrating an operating state of the straw assembly of FIG. 1 which is inverted;

FIG. 12 is a view illustrating the inverted state of a vinyl bag device shown in FIG. 3;

FIG. 13 is a state view of the vinyl bag device shown in FIG. 3 after discharge of solution, in which a vinyl bag clings to a solution straw and a fixture;

FIG. 14 is a detailed configuration view of the fixture shown in FIG. 3; and

FIG. 15 is a view illustrating an alternative assembling example of the vinyl bag and fixture shown in FIG. 3.

### BEST MODE FOR CARRYING OUT THE INVENTION

Now, preferred embodiments of the present invention will be described in more detail with reference to the accompanying drawings.

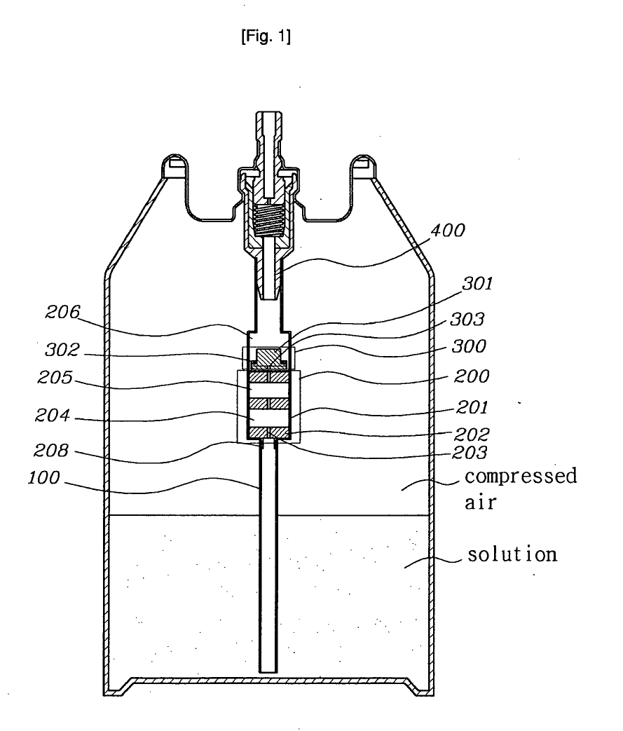

The present invention relates to a straw assembly for use in aerosol or spray injection type packing pressure containers configured to contain solution and compressed air therein. More particularly, as shown in FIG. 1, the straw assembly according to a preferred first embodiment of the present invention, which is installed in a pressure container, comprises: a valve unit 400 installed at an outlet of the container; a safety valve 300 that is located below the valve unit 400 and adapted to prevent discharge of compressed air serving as an injection propellant when the container is inverted; a pressure regulator 200 that is located below the safety valve 300 and adapted to sequentially regulate a pressure of the solution to a desired injection pressure; and a solution straw 100 coupled to a lower end of the pressure regulator 200 to be installed on an extension axis of the pressure regulator 200.

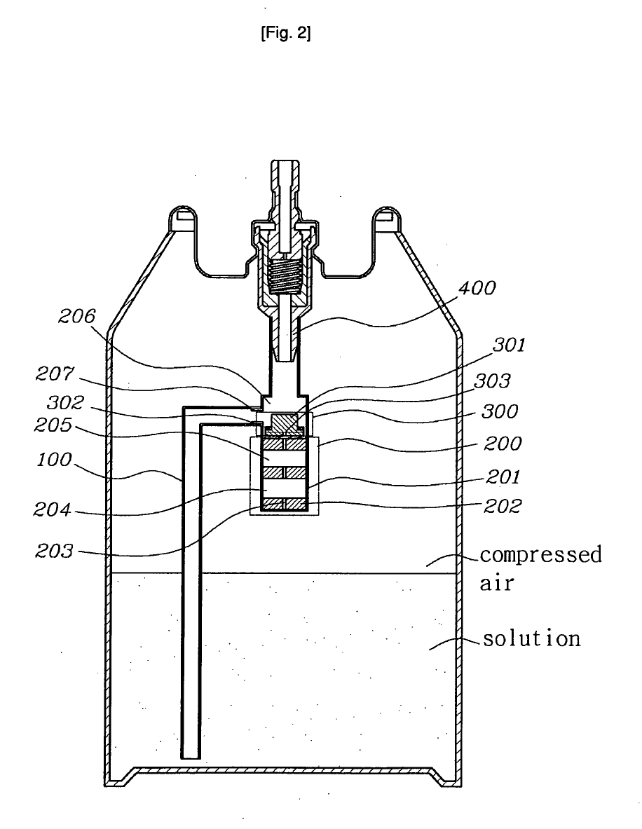

Alternatively, as shown in FIG. 2 illustrating a preferred second embodiment of the present invention, the solution straw 100 may be coupled to a circumferential position of the pressure regulator 200 at a side of the safety valve 300, and more particularly, may be coupled to an upper coupling portion 207 of the pressure regulator 200. Although not shown, also, it will be understood that the solution straw 100 may be directly connected to the valve unit 400 of the pressure container. In this configuration, the safety valve 300 and pressure regulator 200 may be installed below the solution straw 100.

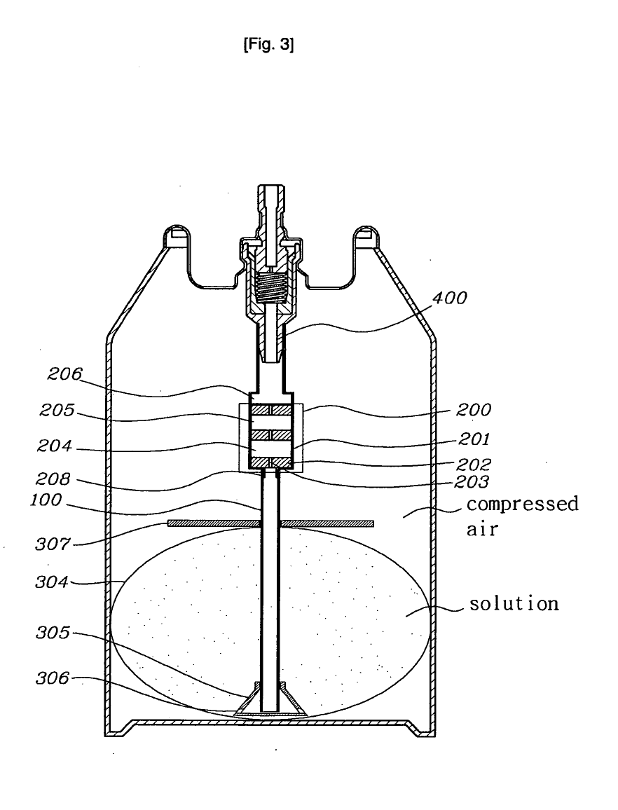

Alternatively, as shown in FIG. 3 illustrating a preferred third embodiment of the present invention, the straw assembly of the present embodiment may comprise a vinyl bag device for preventing the leakage of compressed air and guaranteeing efficient injection of solution at all postures of the container, instead of the above described safety valve 300. The vinyl bag device includes a vinyl bag 304 for the storage of solution, a stopper 307 strongly attached around the solution straw 100 by use of an adhesive or other fastening means to prevent excessive movement of the vinyl bag 304 when the pressure container is inverted or shaked, and a conical fixture 305 strongly attached to a lower end of the solution straw 100 by use of an adhesive or other fastening means to prevent the vinyl bag 304 from clinging to an entrance of the solution straw 100. As will be understood, it should be essentially assumed that the solution straw 100 is coupled to the lower end of the pressure regulator 200 for the use of the above described vinyl bag device. In the case of the present embodiment, more particularly, in order to minimize a residual amount of solution and to prevent the vinyl bag 304 from clogging the entrance of the solution straw 100, it is preferable that the fixture 305 be installed in such a manner that an inner bottom surface of the fixture 305 is spaced apart from a distal end of the solution straw 100 by a slight gap and an outer lower surface of the fixture 305 come into sufficiently close contact with a bottom surface of the container. Additionally, it will be understood that, if a length of the pressure regulator 200 increases, the vinyl bag 304, fixture 305, and stopper 307 may be directly attached to the pressure regulator 200.

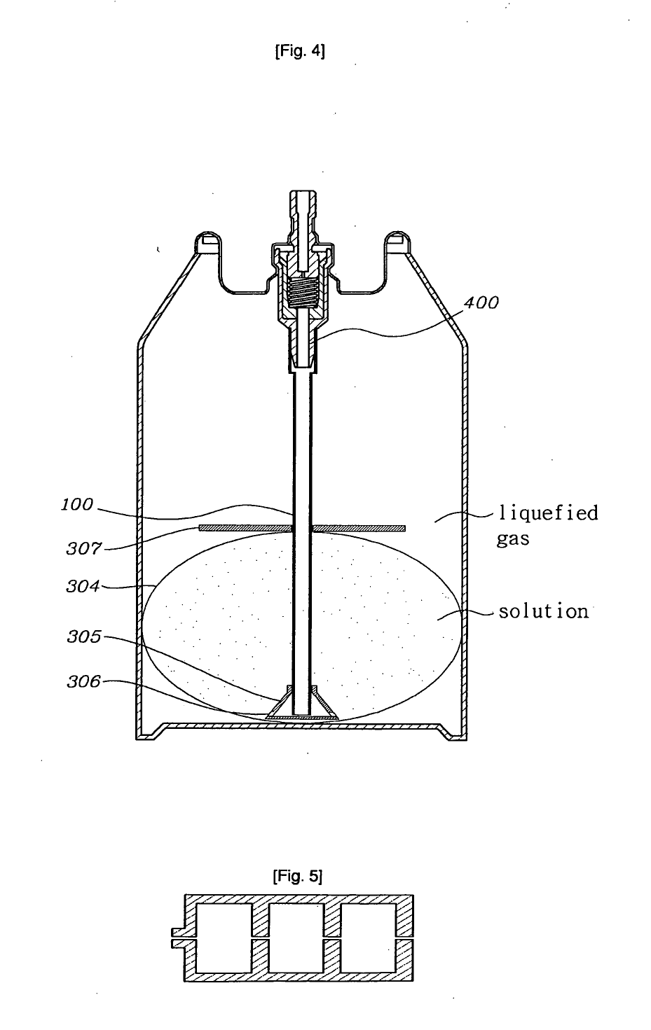

Alternatively, as shown in FIG. 4 illustrating a use example of the straw assembly according to the preferred third embodiment of the present invention, the vinyl bag 304, fixture 305, and stopper 307 may be used in conventional liquefied gas charged type aerosol or spray injection containers.

The pressure regulator 200 is devised on the basis of the principle that a pressure and velocity are inversely proportional to each other, and serves to reduce the pressure of solution by imparting a factional resistance thereto. The pressure regulator 200 includes a pipe 201 forming the outer appearance of the pressure regulator 200, and a plurality of cylindrical members 202 tightly inserted in the pipe 201 to be vertically spaced apart from one another by a predetermined distance so as to define air chambers 204, 205, and 206 therebetween. The cylindrical members 202 may be made of metallic materials or synthetic resins, and are centrally perforated with a narrow hole 203. With this configuration, the pressure regulator 200 acts to sequentially reduce the pressure of solution moving therein by use of the air chambers 204, 205, and 206, so as to spray the solution at a desired injection pressure. Also, to achieve a more accurate sequential regulation in the pressure of the solution to a desired injection pressure, the pressure regulator 200 may further include a plurality of air chambers in addition to the above described three air chambers 204, 205, and 206.

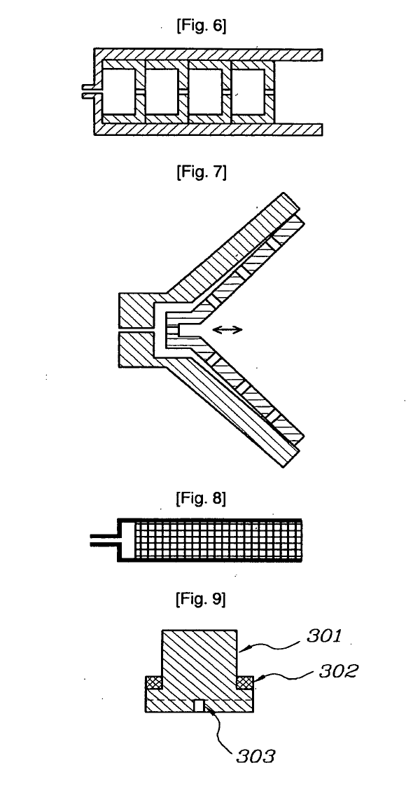

As shown in FIGS. 5 to 8, the pressure regulator 200 may be fabricated by use of a non-metallic filter or other elements capable of responding to the pressure of the solution moving therein. Although not shown, moreover, the air chamber, pressure-sensitive element, hole, or filter included in the pressure regulator 200 may be freely changed in shape, size, material, and assembling method if necessary.

The safety valve 300, which is seated on the uppermost cylindrical member 202 of the pressure regulator 200, is used to prevent the compressed air filled in the container from being suddenly discharged to the outside when the container is inverted because the compressed air tends to be easily expelled differently from liquefied gas having a vapor pressure. The safety valve 300 is designed to be movable by the weight thereof and upon receiving a pressure applied by the pressure regulator 200. The safety valve 300 includes a two-stepped cylinder 301 made of metallic materials or synthetic resins, and a rubber packing 302 fitted around an intermediate stepped portion of the cylinder 301. Preferably, the two-stepped cylinder 301 is formed at a lower surface thereof with a cross-shaped groove 303, to prevent the safety valve 300 from coming into close contact with an upper surface of the uppermost cylindrical member 202 of the pressure regulator 200.

The safety valve 300 may be mounted in an upper portion or lower portion of the pressure regulator 200, and take the form of a ball, cylinder, two-stepped cylinder, a wedge, etc. The rubber packing 302 is used to prevent the leakage of compressed air, and the cross-shaped groove 303 acts to prevent the safety valve 300 from coming into close contact with the pressure regulator 200. It will be understood that the shape and size of the safety valve 300 can be freely changed if necessary.

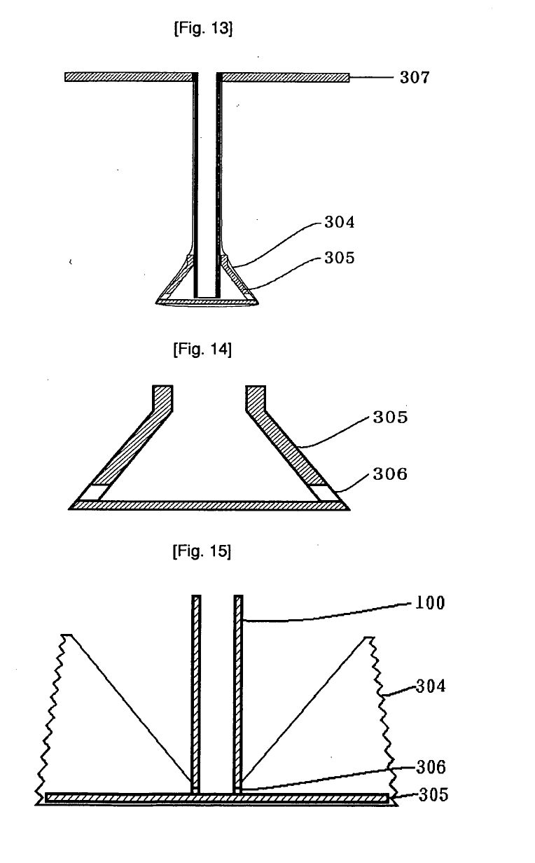

Considering the vinyl bag device used instead of the safety valve 300 in detail, first, the vinyl bag 304 of the vinyl bag device, as shown in FIG. 13, has to be made of a thin and sturdy material. After the discharge of solution as well as under the influence of a pneumatic pressure generated in the container, the vinyl bag 304 is adapted to gradually cling to the solution straw 100 and fixture 305, so as to achieve a reduction in the volume thereof. Although the embodiment of the present invention describes that the vinyl bag 304 is made of vinyl, it will be understood that the vinyl bag 304 may be made of other various materials, such as rubber, and the like. The vinyl bag 304 of the present embodiment preferably has a spherical shape, but the shape of the vinyl bag 304 is changeable in consideration of the shape and volume of the container.

The fixture 305 is made of a non-metallic material, such as plastics, and the like, and perforated with at least one hole. Here, it is noted that the number and size of the hole is changeable in various manners. Considering the configuration of the fixture 305 more specifically, as shown in FIG. 12, the fixture 305 has a bottom area sufficient to support the vinyl bag 304 in consideration of the fact that the vinyl bag 304 is suspended from the lower surface of the fixture 305 when the container is inverted. Also, to minimize a residual amount of solution at the last stage of use, the shape of the fixture 305 may be selected from among a variety of shapes including a conical shape, pyramid shape, spherical shape, etc. so long as it is suitable to minimize the inner volume of the fixture 305.

The stopper 307 may be made of plastics, etc., and the shape of the stopper 307 may be selected from among a variety of shapes including a circular disc shape, conical shape, or the like so long as it can support the vinyl bag 304 when the container is inverted.

As shown in FIG. 15, alternatively, a wrinkled vinyl bag may be used instead of the spherical smooth vinyl bag 304. In this case, the wrinkled vinyl bag may be attached to the lower end of the solution straw 100 to have the role of a stopper. Also, the fixture 305 may be replaced by a circular disc, or the like, attached to the lower end of the solution straw 100 at a position immediately below at least one hole 306 perforated in a distal end portion of the solution straw 100, so as to accomplish the same function as that of the fixture 305. As will be easily understood, the above described vinyl bag device including the vinyl bag 304, fixture 305, and stopper 307 according to the present invention can be freely changed in shape and coupling structure thereof in various manners while achieving the same operation effects as the above description.

In the present invention, since the compressed air is used to substitute liquefied gas conventionally used, the aerosol or spray injection type pressure container for use with the straw assembly of the present invention can be made of synthetic resins, glass, or the like.

Although the present invention discloses that the compressed air is usable as an injection propellant for various aerosol or spray solutions used for industrial, domestic, and other universal purposes, it is noted that any other gases harmless to human bodies, such as high-purity oxygen, etc., may be used as an injection propellant.

Now, an installation procedure of the straw assembly according to the present invention will be explained. First, the pressure regulator 200 and the safety valve 300 are assembled to a lower end of the valve unit 400, and then, the solution straw 100 is assembled to an appropriately selected position, more particularly, a lower or upper position or circumferential position of the pressure regulator 200. With this assembly configuration, the solution may be supplied into the air chamber 206 from the solution straw 100 by way of the pressure regulator 200 and safety valve 300, to thereby be sprayed through the valve unit 400. Alternatively, if an internal pressure of the container is applied to the solution straw 100 so as to directly supply the solution into the air chamber 206, the solution is able to be sprayed to the outside through the valve unit 400 after being mixed with the compressed air that is supplied into the air chamber 206 by way of the pressure regulator 200 and the safety valve 300.

In relation with the preferred third embodiment of the present invention, the pressure regulator 200 is coupled to a lower end of the valve unit 400, the solution straw 100 is installed below the pressure regulator 200, both the vinyl bag 304 and the stopper 307 are installed around the solution straw 100, and the fixture 305 is attached to the lower end of the solution straw 100. In this case, the internal pressure of the vinyl bag 304 always maintains a balance with compressed air received in the container regardless of pressure degradation caused by the reduction of the solution received in the container. Also, the solution received in the vinyl bag 304 is able to be introduced into the fixture 305 through the hole 306 perforated in the fixture 305. If the solution is fed through the solution straw 100, the solution is sequentially reduced in pressure while passing through the pressure regulator 200, thereby being finally injected to the outside of the container through the valve unit 400 at an appropriate injection pressure.

In the case where the present invention is applied to a conventional liquefied gas charged type aerosol or spray container, the solution straw 100 may be directly coupled to the lower end of the valve unit 400, both the vinyl bag 304 and the stopper 307 may be integrally installed around the solution straw 100, and the fixture 305 may be attached to the lower end of the solution straw 100. In this case, the internal pressure of the vinyl bag 304 always maintains a balance with an interior space of the container utilized for inducing expansion of liquefied gas, and the solution received in the vinyl bag 304 is able to be introduced into the fixture 305 through the hole 306 perforated in the fixture 305. If the solution is fed through the solution straw 100, the solution is able to be injected to the outside of the container through the valve unit 400.

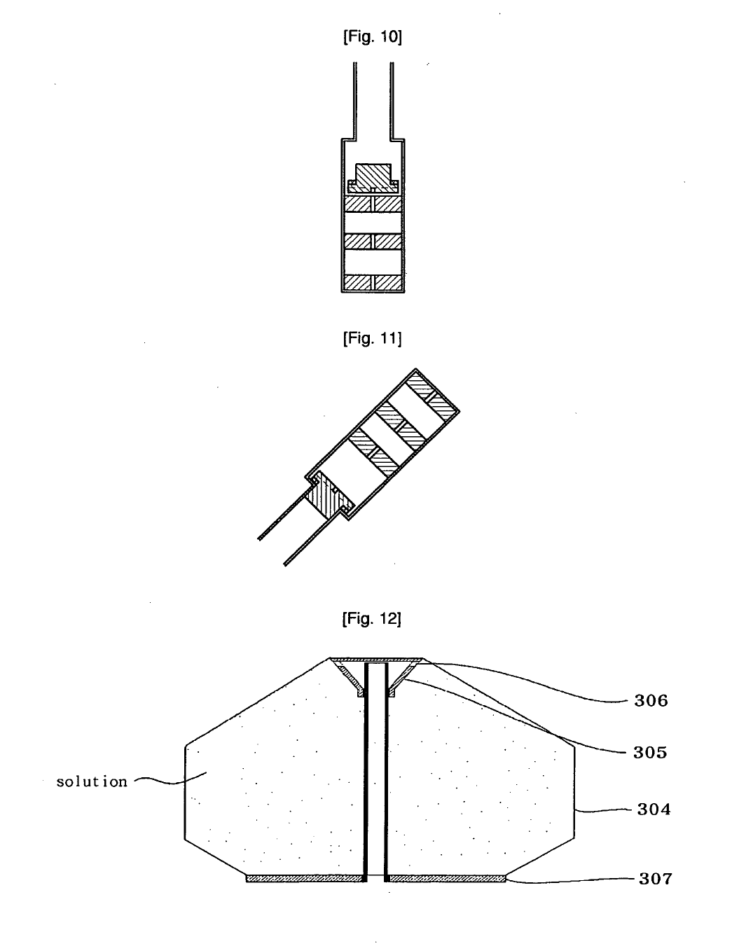

When the container is inverted, the safety valve 300 is displaced in the air chamber 206 to block an exit of the air chamber 206 as shown in FIG. 11, thereby preventing the air chamber 206 from functioning as a passage. With the use of the safety valve 300, even when only the compressed air is introduced into the solution straw 100, it is possible to prevent the compressed air from being discharged to the outside through the valve unit 400.

In the above described configuration, additionally, a check valve may be attached to a lower end or side portion of the container, to facilitate the charge of compressed air.

### INDUSTRIAL APPLICABILITY

As apparent from the above description, when a container is used in a normal upright posture to inject aerosol or spray, high-pressure solution received in the container is sequentially reduced in pressure while passing through a pressure regulator. Thereby, the solution is discharged to the outside of the container. In the present invention, when the container is inverted, it is possible to prevent discharge of the compressed air.

Accordingly, the present invention has the following several effects.

In View of the Quality of Products:

Firstly, the present invention can achieve a high injection pressure, and this enables spray of fine particles over a relatively wide area;

Secondly, differently from conventional pressure containers requiring a filler receiving space, the present invention can achieve an increase in the space utility of the container based on the compression degree of the compressed air;

Thirdly, the present invention can achieve a rapid spray operation regardless of the surrounding temperature and have no need for shaking the container in order to increase an internal pressure of the container;

Fourthly, conventionally used liquefied gas has a risk of failing to spray solution due to a low vapor pressure thereof during winter, but the compressed air of the present invention has no problem of spray failure in all seasons; and

Fifthly, conventional pressure containers tend to provide a cold contact feeling because they are fabricated by iron/aluminum materials in consideration of safety, but the container of the present invention can be made of synthetic resins, and thus, can achieve an improvement in contact feeling in use and have a variety of shapes to fulfill the consumer's different tastes.

In View of Environmental Protection and Safety:

Firstly, in the prior art, when liquefied gas used as a filler is discharged to the atmosphere, people are exposed to butadiene, benzene, etc., and thus, have the risk of getting cancer or leucosis. However, the compressed air of the present invention has the same composition as the atmospheric air and has no components harmful to human bodies;

Secondly, differently from the prior art using liquefied gas that has a high explosive power when being exposed to flame, the present invention using the compressed air has no risk of explosion; and

Thirdly, the present invention can eliminate any possibility of accidents differently from prior art products having a high risk of accidents by liquefied gas remained therein upon disposal.

In View of Economics:

Firstly, by substituting the compressed air for liquefied gas, it is possible to achieve a reduction in product costs;

Secondly, eliminating the use of the liquefied gas has the effect of reducing additional costs required for the management of dangerous materials; and

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A straw assembly for compressed air, which is usable in an aerosol or spray injection type packing pressure container containing solution and compressed air substituting for liquefied gas, comprising:
a valve unit to discharge the solution out of the container;
a safety valve located below the valve unit and adapted to prevent discharge of the compressed air serving as an injection propellant when the container is inverted;
a pressure regulator located below the valve unit and adapted to sequentially regulate a pressure of the solution to an injection pressure; and
a solution straw coupled to a lower end of the pressure regulator to be installed on an extension axis of the pressure regulator.

2. The straw assembly according to claim 1, wherein an installation position of the safety valve is located above the pressure regulator.

3. The straw assembly according to claim 1, wherein an installation position of the safety valve is located below the pressure regulator.

4. The straw assembly according to any one of claims 1 to 3, wherein the pressure regulator comprises:
a pipe forming the outer appearance of the regulator; and
a plurality of cylindrical members each having a narrow hole perforated in the center thereof, the cylindrical members being tightly inserted in the pipe to be vertically spaced apart from one another by a predetermined distance, so as to define air chambers therebetween.

5. The straw assembly according to any one of claims 1 to 3, wherein the safety valve comprises:
a two-stepped cylinder; and
a rubber packing fitted around an intermediate stepped portion of the two-stepped cylinder, so as to prevent leakage of the compressed air, and wherein the two-stepped cylinder is formed at a lower surface thereof with a cross-shaped groove to prevent the safety valve from coming into close contact with the pressure regulator.

6. The straw assembly according to claim 1, wherein the packing container is made of synthetic resins.

7. The straw assembly according to claim 1, wherein gas harmless to human bodies, including high-purity oxygen, is used as the injection propellant.

8. A straw assembly for compressed air, which is usable in an aerosol or spray injection type packing pressure container containing solution and compressed air substituting for liquefied gas, comprising:
a valve unit to discharge the solution out of the container;
a pressure regulator located below the valve unit and adapted to sequentially regulate a pressure of the solution to an injection pressure;
a solution straw coupled to a lower end of the pressure regulator to be installed on an extension axis of the pressure regulator; and
a vinyl bag device attached to the solution straw and adapted to allow the solution to be injected without the leakage of the compressed air, the vinyl bag device comprising a vinyl bag, a fixture, and a stopper.

9. The straw assembly according to claim 8, wherein:
the vinyl bag has a spherical shape;
the fixture is a hollow member having a truncated conical cross section, the fixture being formed, through a lower portion thereof, with at least one hole; and
the stopper has a circular disc shape.

10. The straw assembly according to claim 8 or 9, wherein:
the spherical vinyl bag is replaced by a wrinkled vinyl bag, which is attached to the lower end of the solution straw to perform the role of the stopper; and
the fixture is replaced by a circular disc attached to the lower end of the solution straw at a position immediately below at least one hole perforated in a distal end portion of the solution straw.

11. A straw assembly for liquefied gas, which is usable in an aerosol or spray injection type packing pressure container containing solution and liquefied gas, comprising:
a valve unit to discharge the solution out of the container;
a solution straw coupled to a lower end of the valve unit; and
a vinyl bag device attached to the solution straw and adapted to allow the solution to be injected without the leakage of the liquefied gas, the vinyl bag device comprising a vinyl bag, a fixture, and a stopper.
